(19) United States
(12) Patent Application Publication
(10) Pub. No.: US 2003/0123941 A1
(43) Pub. Date: Jul. 3, 2003

(54) Pocket hole drilling and screw installation jig for workpieces

(76) Inventor: Eugene E. Emerson, Whittier, CA (US)

Correspondence Address: PARK & SUTTON LLP, 3255 WILSHIRE BLVD, SUITE 1110, LOS ANGELES, CA, 90010, US

(21) Appl. No.: 10/038,928

(22) Filed: Dec. 31, 2001

(51) Int. Cl. B23B 49/02

(52) U.S. Cl. 408/103; 408/115 R

(57) ABSTRACT

A pocket hole drilling and screw installation jig for workpieces is provided. The jig comprises a bar-shaped base having a flat surface to contact workpieces, a fixed stop and a movable stop to secure workpieces, a clamp for holding the workpieces together; and a fixed or movable drill guide for guiding a drill for forming a pocket hole. The drill guide has a body, and through holes obliquely formed in the body. The body has a flat lower surface, which is flush with the flat surface of the base. Each of the through holes forms a drill guide portion having a lower end and an upper end. The lower end terminates flush with the lower surface of the body. A stop flange limiting the movement of a drill bit forming pocket holes is provided at the upper end of the drill guide portion.

### BACKGROUND OF THE INVENTION

The present invention relates to a jig for woodworking. More particularly, the invention relates to a jig for drilling pocket holes in workpieces and installing screws into the pocket holes.

Prior art jigs for preparing pocket hole joints in wooden workpieces require the steps of clamping of a single workpiece with the jig for drilling pocket holes, removing the workpiece from the jig, attaching the workpiece to a second workpiece either by hand or by a second securing device, depositing screws into the pocket holes, and releasing the assembled workpieces.

Also, clamping mechanisms of prior art jigs for preparing pocket hole joints work in the direction perpendicular to drill guides which guide drill bits for drilling pocket holes.

Accordingly, there has been a demand for a jig with which holding workpieces during drilling pocket holes and installing screws in the pocket holes to assemble the workpieces can be done with one clamping step.

### SUMMARY OF THE INVENTION

The present invention is contrived to overcome the conventional disadvantages. Therefore, an object of the invention is to provide a jig for securing workpieces together for drilling pocket holes and maintaining workpieces' position accurately while screwing them together.

Another object of the invention is to provide a jig that secures workpieces in their finished position before drilling pocket holes and screwing the workpieces together.

Still another object of the invention is to provide a jig for forming pocket hole joints that is compact, portable and easy to use.

To achieve the above-described objects, in accordance with an embodiment thereof, the invention provides a pocket hole drilling and screw installation jig for workpieces which comprises a bar-shaped base having a flat lower surface along its length, a first end, and a second end for contacting one or more workpieces with the lower surface, a first stop fixed at the first end of the base for securing a first workpiece, a second stop movably provided along the base for securing a second workpiece, a clamp for holding the workpieces together, and a drill guide movably provided along the base for guiding a drill for forming a pocket hole. The drill guide has a body, and through holes obliquely formed in the body. The body has a flat lower surface and an upper surface and the lower surface of the body is substantially parallel with the lower surface of the base and each of the through holes forms a drill guide portion. The drill guide portion has a lower end and an upper end, and the lower end terminates flush with the lower surface of the body. The angle between the holes at the drill guide and the lower surface of the base is approximately 14 degrees.

The drill guide portion may be made of a bushing and inserted into the through hole of the drill guide. The bushing is made of hardened steel.

The guide portion has a stop flange at the upper end to limit drilling depth of a drill to form a pocket hole. The body of the drill guide is made of cast aluminum, extruded aluminum, or molded plastic.

The drill guide further comprises a clamp. The clamp secures the drill guide to the base and allows the lower surface of the body to be pressed against a workpiece to be drilled.

The clamp of the drill guide comprises a nut and a knob. The nut has a head and a threaded portion. The knob has a threaded portion that engages with the threaded portion of the nut. The body of the drill guide further comprises a bore. The threaded portion of the nut passes through the bore, and the base further comprises a guide channel in which the head of the nut slides and is secured.

Alternatively, for the clamping of the drill guide, the base further comprises two sidewalls and each of the sidewalls has a groove. The body of the drill guide further has two sidewalls connecting the upper surface and the lower surface. The lower surface has an opening. Each of the sidewalls has a groove and a plurality of bores. The opening of the lower surface, the sidewalls, and the upper surface form a channel receiving the base. The clamp of the drill guide has a plurality of bolts, and two keys having a plurality of threaded holes. The keys are inserted between the groove of the base and the groove of the drill guide, and the bolts pass through the bores of the drill guide and engage with the threaded holes of the keys.

The base further comprises a channel formed along its length. The first stop comprises a first wall contacting the first workpiece, and a second wall positioned opposite to the first wall. The clamp comprises a rod housed in the channel of the base, a spring, an end cap fixed at the second end of the base and housing the spring, and a cam lever. The rod has a first end, a second end, and a stop provided at the first end. The end cap has a first wall covering the second end of the base and a second wall positioned opposite to the first wall. The spring is positioned around the rod between the second wall of the end cap and the stop of the rod. The cam lever is pivotally attached to the second end of the rod and abuts the second wall of the first stop. The second stop comprises a lock engaging the rod of the clamp for allowing movement of the second stop only in the direction toward the first stop when the lock is engaged and for allowing movement of the second stop in both direction along the base when the lock is released.

In accordance with another embodiment thereof, the invention provides a pocket hole drilling and screw installation jig for workpieces comprising a bar-shaped base having a flat lower surface along its length, a first end, and a second end for contacting one or more workpieces with the lower surface, a drill guide attached at the first end of the base for guiding a drill for forming a pocket hole, a first stop movably provided along the drill guide for securing a first workpiece, a second stop movably provided along the base for securing a second workpiece, and a clamp for holding the workpieces together.

The drill guide has a body and drill guide portions. The body has a flat lower surface and an upper surface. The lower surface of the body is flush with the flat surface of the base. Each of the drill guide portions is formed by a through hole obliquely formed in the body. The hole has a lower end and an upper end and the lower end terminates flush with the lower surface of the body.

The base further comprises a channel formed along its length. The drill guide further comprises a first end inserted into the channel of the base for attaching the drill guide to the base, and a second end positioned opposite to the first end and having one or more channels to receive the first stop. The first stop has a stop contacting the first workpiece and a fastener fixing the stop on the drill guide. The clamp comprises a rod housed in the channel of the base, a spring, an end cap fixed at the second end of the base and housing the spring, and a cam lever. The rod has a first end, a second end, and a stop provided at the first end. The end cap has a first wall covering the second end of the base and a second wall positioned opposite to the first wall. The spring is positioned around the rod between the second wall of the end cap and the stop of the rod. The cam lever is pivotally attached to the second end of the rod and abuts the second end of the drill guide. The second stop comprises a lock engaging the rod of the clamp for allowing movement of the second stop only in the direction toward the first stop when the lock is engaged and for allowing movement of the second stop in both direction along the base when the lock is released.

The advantages of the present invention are numerous in that: (1) forming pocket holes and installing screws in the pocket holes are performed with single clamping step of workpieces; (2) necessary adjustments to the workpieces' final assembled position can be readily made before drilling, ensuring the best position of the pocket holes; (3) the jig can accommodate varying dimensions of the workpieces; and (4) workpieces are additionally tightened by the drill guide, providing smooth and accurate drilling.

Although the present invention is briefly summarized, the fuller understanding of the invention can be obtained by the following drawings, detailed description and appended claims.

### BRIEF DESCIPTION OF THE DRAWINGS

These and other features, aspects and advantages of the present invention will become better understood with reference to the accompanying drawings, wherein:

FIG. 1 is a front elevational view of a pocket hole drilling and screw installation jig according to an embodiment of the present invention;

FIG. 2 is a cross-sectional view taken along 2-2 in FIG. 1;

FIG. 3 is a bottom plan view of the jig;

FIG. 4 is a cross-sectional view taken along 4-4 in FIG. 1;

FIG. 5 is an elevational view of a first stop;

FIG. 6 is a cross-sectional view of a second stop taken along 6-6 in FIG. 1;

FIG. 7 is a plan view of a body of the second stop;

FIG. 8 is an elevational view of the body of the second stop;

FIG. 9 is a left side elevational view of the body of the second stop;

FIG. 10 is a right side elevational view of the body of the second stop;

FIG. 11 is a plan view of a slider of the second stop;

FIG. 12 is a front elevational view of the slider of the second stop;

FIG. 13 is a bottom plan view of the slider of the second stop;

FIG. 14 is a right side elevational view of the slider of the second stop;

FIG. 15 is a left side elevational view of the slider of the second stop;

FIG. 16 is a side elevational view of a locking element of the second stop;

FIG. 17 is a front elevational view of the locking element of the second stop;

FIG. 18 is an elevational view showing a released state of the second stop;

FIG. 19 is an elevational view showing a locked state of the second stop;

FIG. 20 is a plan view of an end cap.

FIG. 21 is an elevational view of the end cap.

FIG. 22 is a left side elevational view of the drill guide;

FIG. 23 is a front elevational view of the drill guide;

FIG. 24 is a bottom plan view of the drill guide;

FIG. 25 is a partial, front elevational view of the jig showing the step of positioning and clamping workpieces;

FIG. 26 is a cross-sectional view taken along 26-26 in FIG. 3, showing the step of guiding a drill for forming pocket holes;

FIG. 27 is a cross-sectional view similar to FIG. 26, showing the step of drilling pocket holes;

FIG. 28 is a cross-sectional view similar to FIG. 27, showing the step of screw installation;

FIG. 29 is a partial, cross-sectional view of the jig showing three workpieces positioned horizontally;

FIG. 30 is a cross-sectional view showing an alternate clamping mechanism of a drill guide;

FIG. 31 is a cross-sectional view taken along 31-31 in FIG. 30;

FIG. 32 is a partial front elevational view of a pocket hole drilling and screw installation jig according to another embodiment of the present invention;

FIG. 33 is a plan view of a drill guide;

FIG. 34 is a cross-sectional view taken along 34-34 in FIG. 33;

FIG. 35 is a left side elevational view of the drill guide;

FIG. 36 is a right side elevational view of the drill guide;

FIG. 37 is an elevational view of a first stop;

FIG. 38 is a plan view of the first stop; and

FIG. 39 is a plan view of a nut for the first stop.

### DETAILED DESCRIPTION OF THE PREFERRED EMBODIMENTS

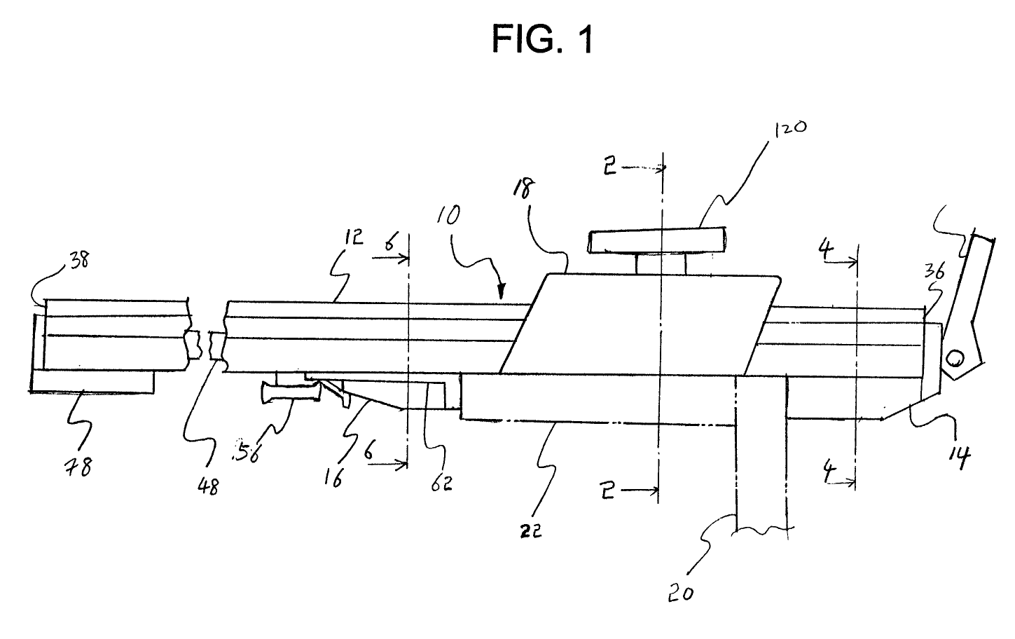

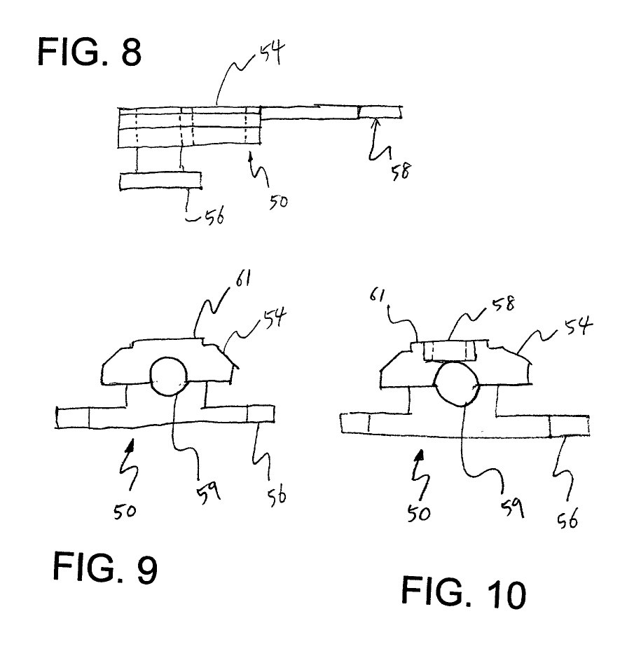

FIGS. 1-31 show a pocket hole drilling and screw installation jig 10 according to the first embodiment of the present invention. The jig 10 may also be used as a straight edge clamping device for woodworking.

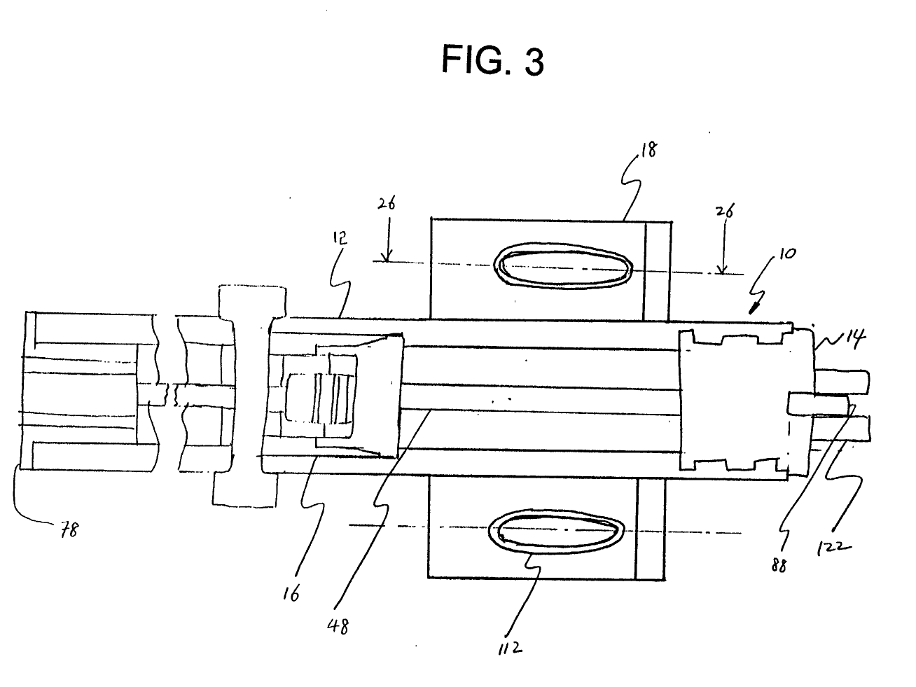

As shown in FIGS. 1 and 3, the jig 10 includes a bar-shaped base or a straight edge 12, a first stop 14, a second stop 16, and a drill guide 18. FIG. 1 also shows two workpieces 20, 22 with imaginary lines.

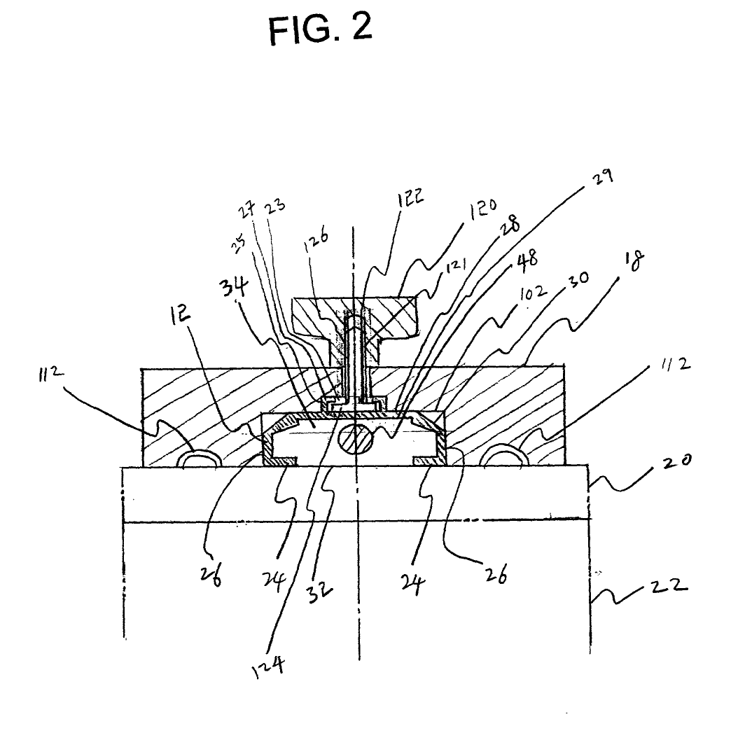

As shown in FIG. 2, the base 12 has a constant cross-section and is typically made of extruded aluminum. The cross-section of the base is defined by two lower walls 24 that form a flat surface which is flush with a surface of the workpiece 20, two sidewalls 26 that extend upward from the lower walls 24, an upper wall 28, and two slant walls 30 that connect the upper wall 28 and the sidewalls 26. The angle between the slant walls 30 and sidewalls 26 is approximately 45 degrees. An opening 32 is formed between the lower walls 24. All of the walls 24, 26, 28, 30, and the opening 32 form an open channel 34. The base also has two ends 36, 38. Another and smaller open channel 23 is defined by two protrusions 25 protruding upward from the upper wall 28 and another two protrusions 27 protruding toward each other from the protrusions 25.

The upper wall 28 has a recess 29. The recess 29 provides additional interlocking effect to elements received in the channel 34, that is, the first stop 14 and the second stop 16, etc. The recess 29 is rectangular and has a depth of approximately one sixteenth of an inch, or one eighth of an inch. The recess 29 has a width almost as that of the upper wall 28. The width and depth of the recess are chosen to ease the manufacturing process and to increase the interlocking ability between the base 12 and the elements received in the base. More than one recesses may provided in the upper wall 28. The recess may be provided in other walls defining the channel 34.

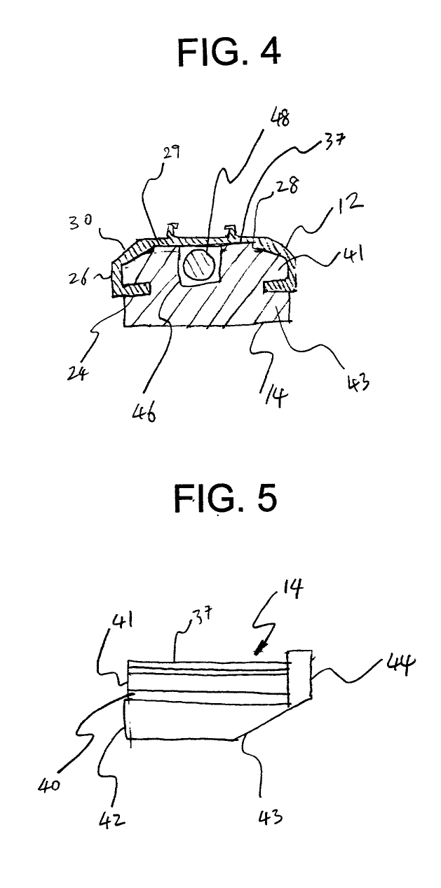

The first stop 14 is fixed to the end 36 of the base 12 and is used to secure the workpiece 20. As shown in FIGS. 4 and 5, the first stop 14 has grooves 40 in which the lower walls 24 of the base 12 fit tightly. The portion of the first stop 14 received in the channel 34 of the base 12 forms a body 41 of the first stop 14. The body 41 has a shape that is reverse to the channel 34 so that the first stop 14 and the base 12 interlock. The body 41 has a projection 37 that interlocks with the recess 29 of the base 12. The portion of the first stop 14 outside the channel 34 forms a stop 43. The stop 43 has a jaw or wall 42 that contacts the workpiece 20. The first stop 14 also has an end wall 44 that is opposite to the jaw 42 and covers the end 36 of the base 12, and a channel 46 that receives a rod 48. The rod 48 is received within the channel 34 of the base 12.

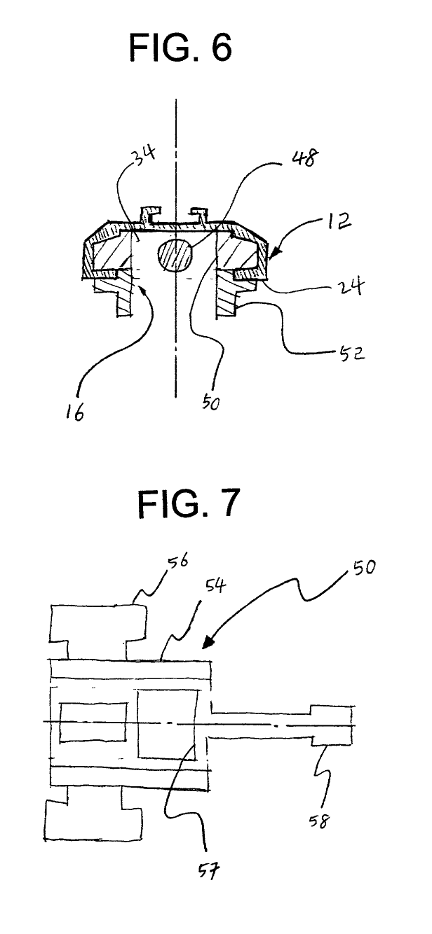

The second stop 16 is received in the channel 34 of the base 12 and movable along the base 12. The second stop 16 is used to secure the workpiece 22. As shown in FIG. 6, the second stop 16 has a body 50 that slides in the channel 34 of the base 12, and a slider 52 that slides in the channel 34 and along the lower wall 24 of the base 12 and contacts the workpiece 22.

FIGS. 7-10 show the body 50 of the second stop 16. The body 50 has a sliding portion 54, a handle 56, an opening 57, a stop 58, and a hole 59. The sliding portion 54 has a shape that is reverse to the shape of the channel 34 so that the sliding portion 54 and the channel 34 interlock. The sliding portion 54 has a projection 61 that interlocks with the recess 29 of the base 12. The projection 61 is rectangular and has a height of approximately one sixteenth of an inch, or one eighth of an inch. The opening 57 is provided in the sliding portion 54. The handle 56 is provided below the sliding portion 54 so that a worker can hold it by hand to move the second stop 16 along the base 12. The stop 58 horizontally extends from the sliding portion 54. The hole 59 is provided in the middle of the second stop 16 to receive the rod 48.

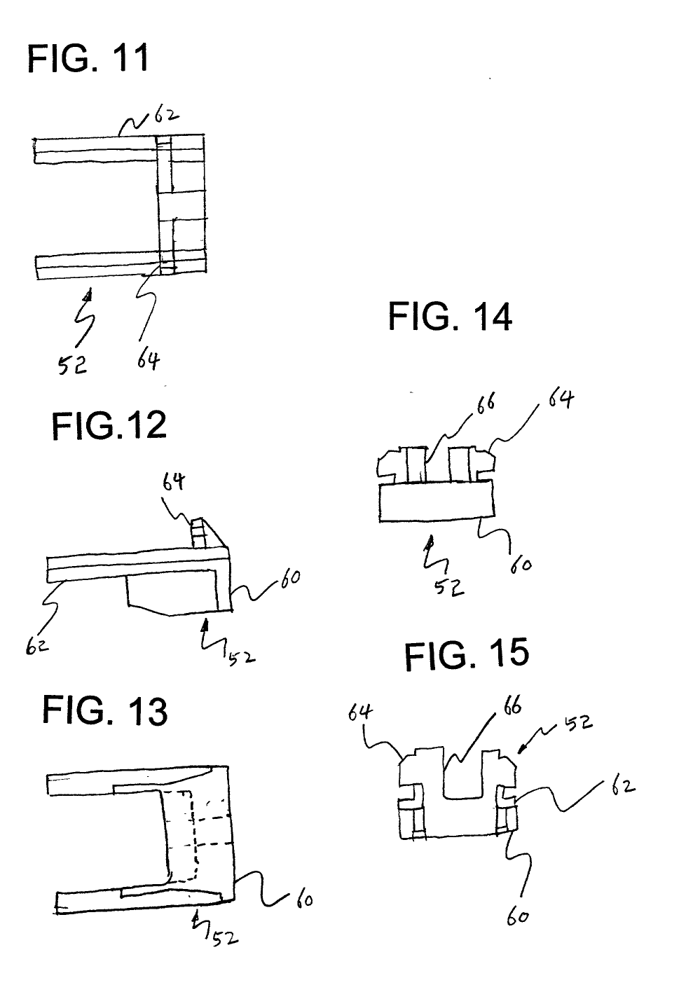

FIGS. 11-15 show the slider 52 of the second stop 16. The slider has the role of a stop securing a workpiece. The slider has a jaw 60, a rail 62, a projection 64, and a channel 66. The rail 62 slides over the lower wall 24 of the base 12. The jaw 60 is provided below the rail 62 and contacts the workpiece 22. The projection 64 is provided above the rail 62 and has a shape that is reverse to the shape of the channel 34 of the base 12 so that the projection 64 and the channel 34 interlock. The channel 66 receives the rod 48.

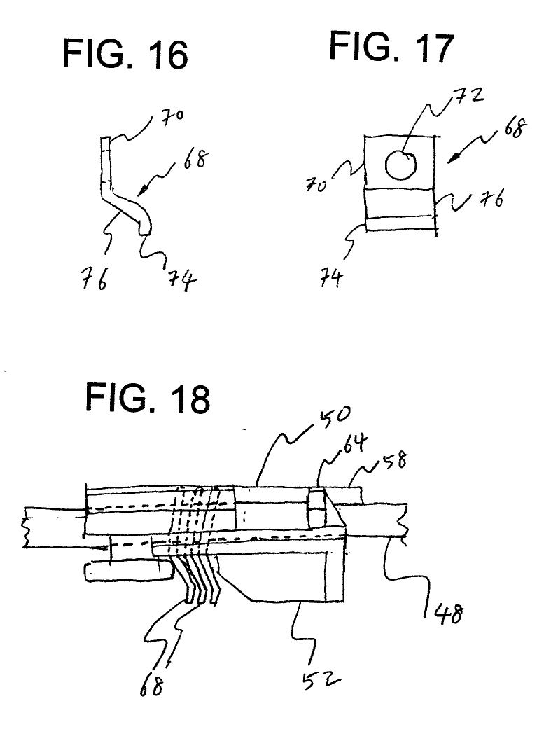

FIGS. 16 and 17 show a locking element 68. The locking element 68 has a flat portion 70, a hole 72 provided in the flat portion 70, an end 74, and a bent portion 76 that connects the flat portion 70 and the end 74.

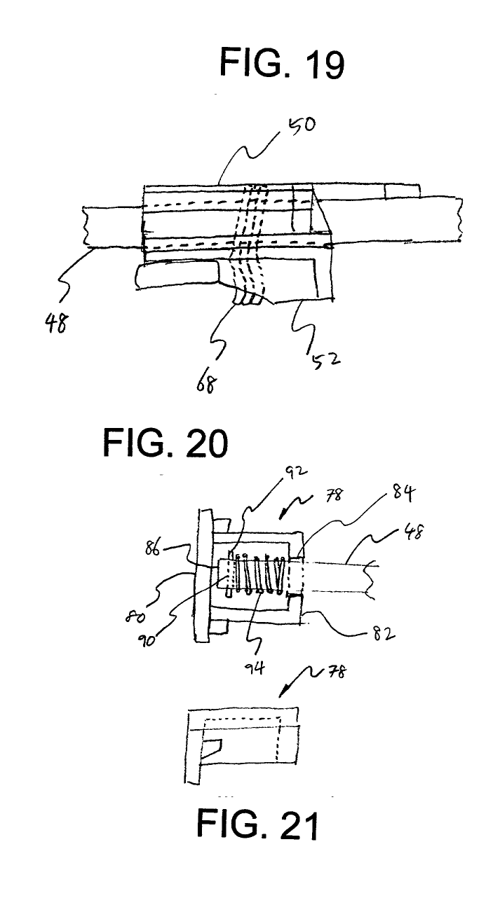

FIG. 18 shows a released state of the second stop 16. FIG. 19 shows a locked state of the second stop 16. A plurality of the locking elements 68 is positioned in the opening 57 of the second stop 16. The rod 48 passes through the hole 59 of the second stop 16 and the holes 72 of the locking elements 68. In the released state, the body 50 is away from the slider 52 so that there are spaces between the locking elements 68 and thus, the locking elements 68 are loose from each other and from the rod 48. The second stop 16 can move along the rod 48 freely. The body's away movement is stopped when the projection 64 of the slider contacts the stop 58 of the body 50. In the locked state, the body 50 moves toward the slider 52 and the locking elements 68 are tightened between the body 50 and the slider 52 so that there are no gaps between the locking elements 68. Thus, in the locked state, the slider 52 moves integrally with the body 50.

In the locked state, the second stop 16 can move toward the first stop since the body 50 pushes the locking elements 68 near the center of the rod 48 and the pushing force is applied uniformly around the hole 72, and the locking elements 68 can slide along the rod 48. However, moving in reverse direction is blocked since the slider 52 pushes the ends 74 of the locking element 48 and the pushing force is applied at a point offset from the center of the holes 72 and the rod 48, thereby locking the holes 72 on the rod 48.

FIGS. 20 and 21 show an end cap 78 that is fixed at the end 38 of the base 12. The end cap 78 has a wall 80 that covers the end 38, and a wall 82 that is opposite to the wall 80. The wall 82 has a channel 84 that receives the rod 48. The rod 48 has two ends 86, 88. A hole 90 is provided at the end 86 of the rod 48. A pin 92 is inserted into the hole 90 forming a stop. A spring 94 surrounds the rod 48 between the pin 92 and the wall 82 of the end cap 78 so that displacement of the spring 94 is confined between the pin 92 and the wall 82.

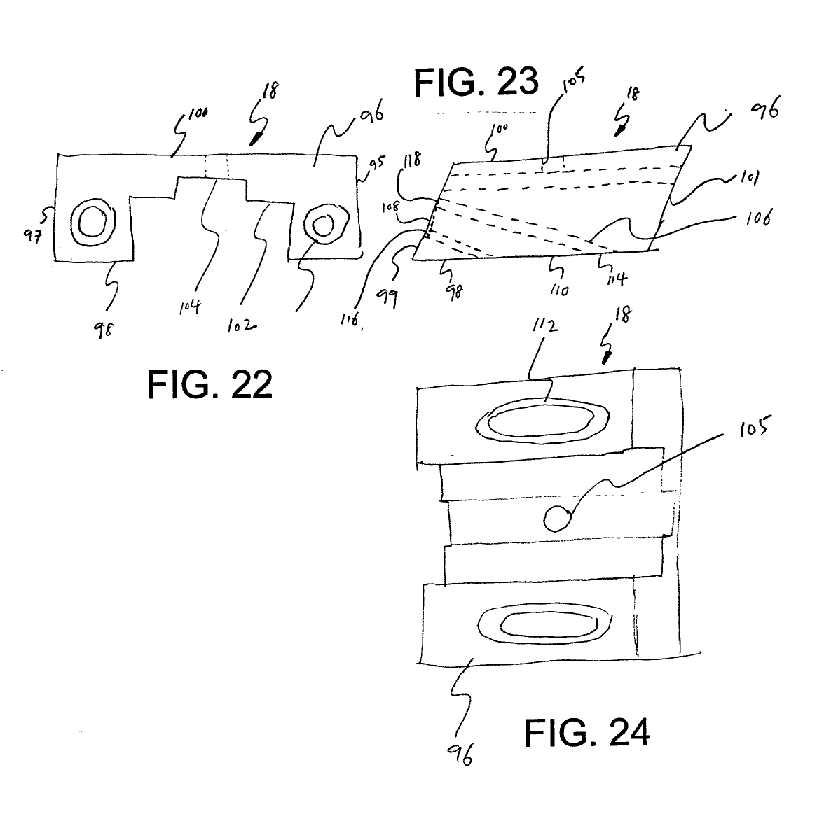

FIGS. 22-24 show the drill guide 18. The drill guide 18 has a body 96. The body has a flat lower surface 98, an upper surface 100, and two sidewalls 95, 97 and two slant walls 99, 101 connecting the lower surface 98 and the upper surface 100. The lower surface 98 is parallel with the lower wall 24 of the base 12 when the drill guide 18 is assembled in the jig 10. The lower surface 98 has a recess 102 formed in the middle of the lower surface 98. A smaller recess 104 is formed in the middle of the recess 102. The recesses 102, 104 receive the base 12 such that the drill guide 18 can slide over the base 12. The recess 104 has a hole 105 in the middle of it. The body 96 further has two through holes 106 longitudinally and obliquely formed within the body 96. The hole has an upper end 108 and a lower end 110. The lower end 110 terminates flush with the lower surface 98. The upper end 108 of the hole 106 is positioned at the slant wall 99. The angle between the hole 106 and the lower surface 98 is approximately 14 degrees.

The material of the body 96 should be rigid to support a drill during drilling pocket holes in the workpiece and should withstand the heat associated with the drilling. Cast, extruded aluminum or molded heat resistant plastic is suitable for the material.

Two drill guide portions 112 that have a shape of a bushing is inserted into the hole 106 of the body 96. Each of the drill guide portions 112 has a lower end 114 and an upper end 116. The lower end 114 terminates flush with the lower surface 98. The upper end 116 of the hole 106 is positioned at the slant wall 99. A stop flange 118 is formed at the upper end 116 of the drill guide portion 112 to limit drilling distance when pocket holes are drilled. The material of the drill guide portion 112 should be resistant to the friction and wear produced during drilling pocket holes in the workpiece. Hardened steel is suitable for the material.

Alternatively, the drill guide portions 112 may not be provided and the holes 106 may act as drill guide portions. In this case, a stop flange is formed on the upper ends 108 of the holes 106.

Referring to FIGS. 2 and 22-24, how the drill guide 18 is clamped to the base 12 is explained. A knob 120 having a threaded hole 121 is engaged with a nut 123 having a head 124 and a threaded portion 126. The threaded portion 126 of the nut 123 passes through the hole 105 of the drill guide 18. The head 124 is slidably received in the channel 23 of the base 12. As the knob 120 is tightened, the drill guide 18 is pressed against the workpiece 20, and the lower surface 98 of the drill guide 18 is held securely against the workpiece.

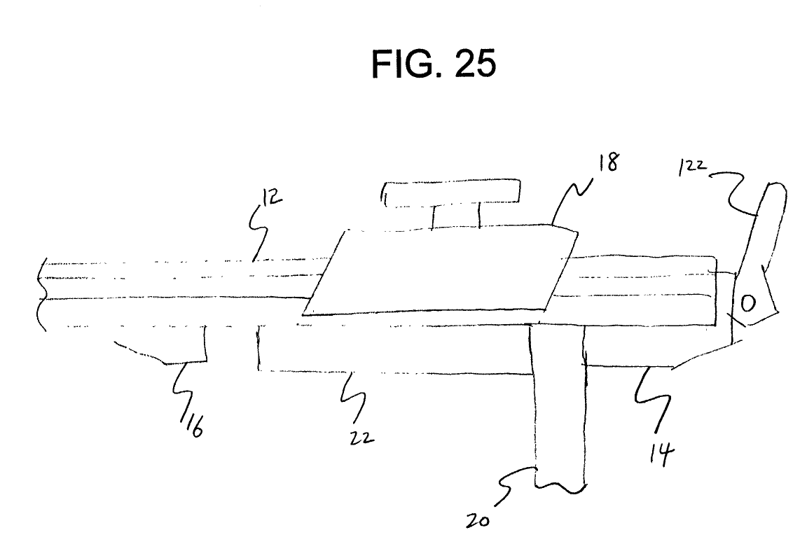

FIGS. 25-28 show the steps that occur during the operation of drilling pocket holes and assembling the workpieces. FIG. 25 shows the jig 10 and workpieces 20, 22 before they are secured between the stops 14, 16. The workpieces 20, 22 are positioned as their final state to be assembled. The workpiece 22 contacts the lower wall 24 of the base 12. The workpiece 20 is positioned perpendicular to the workpiece 22. The second stop 16 has not moved toward the workpiece 22 yet. A cam lever 122 is pivotally provided at the end 88 of the rod 48 and abuts the end wall 44 of the first stop 14, and is shown in a released state.

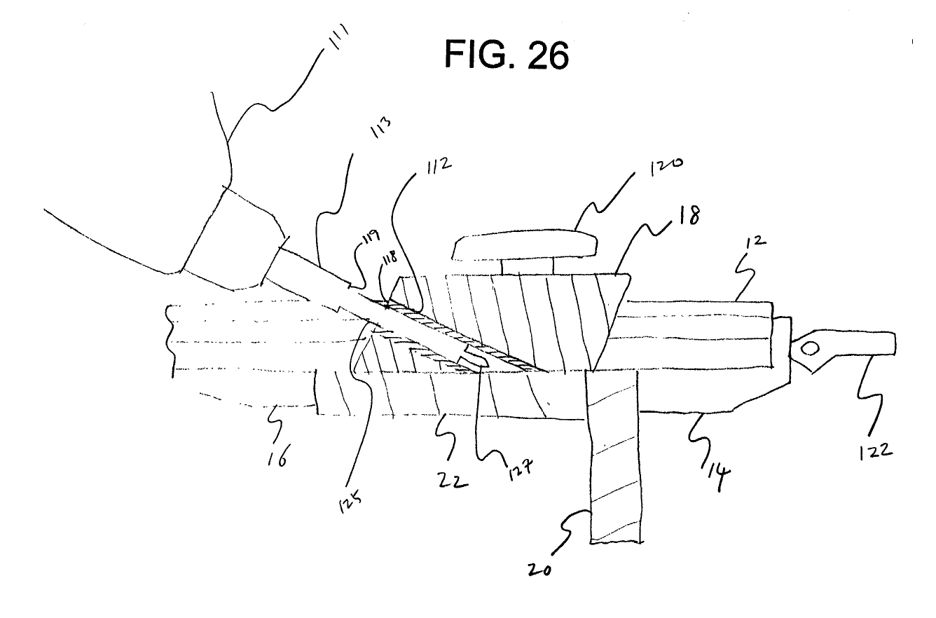

FIG. 26 shows that the workpieces 20, 22 clamped between the first stop 14 and the second stop 16. The second stop 16 is moved toward the first stop 14 such that the stops 14, 16 tightly contact the workpieces 20, 22. The cam lever 122 is now pivoted to an engaging state. By the cam action of the cam lever 122, the rod 48 is pulled out from the first stop 14 by a predetermined distance. As the rod 48 is pulled out, the spring 94 is compressed within the end cap 78. When the second stop 16 is moved toward the first stop, the second stop 16 is locked to the rod 48 as explained above referring FIG. 19. Therefore, pulling out of the rod 48 forces the jaw 60 of the second stop 16 to push the workpiece 22 strongly, and the workpieces 20, 22 are tightly clamped. Then the drill guide 18 is slides over the base 12 to a precise location for drilling pocket holes into the workpiece 22. Then the knob 120 is tightened and the drill guide 18 is fixed to the base 12 and pressed against the workpiece 22 providing additional clamping effect for the workpieces 20, 22. Then a drill bit 113 secured in a chuck of a portable drill 111 is inserted into the drill guide portion 112.

The elements related to clamping workpieces, the first stop 14, the second stop 16, the rod 48, the end cap 78, the spring 94, and the cam lever 122 are all positioned in a plane parallel and near to the lower wall 24 of the base 12.

The drill bit 113 has a pocket forming portion 125, a smaller diameter pilot hole forming portion 127 protruding from the pocket forming portion 125 and forming the free end of the drill bit, and a step shank 119 that abuts with the stop flange 118 of the drill guide portion 112 to limit the drilling distance of the drill bit 113.

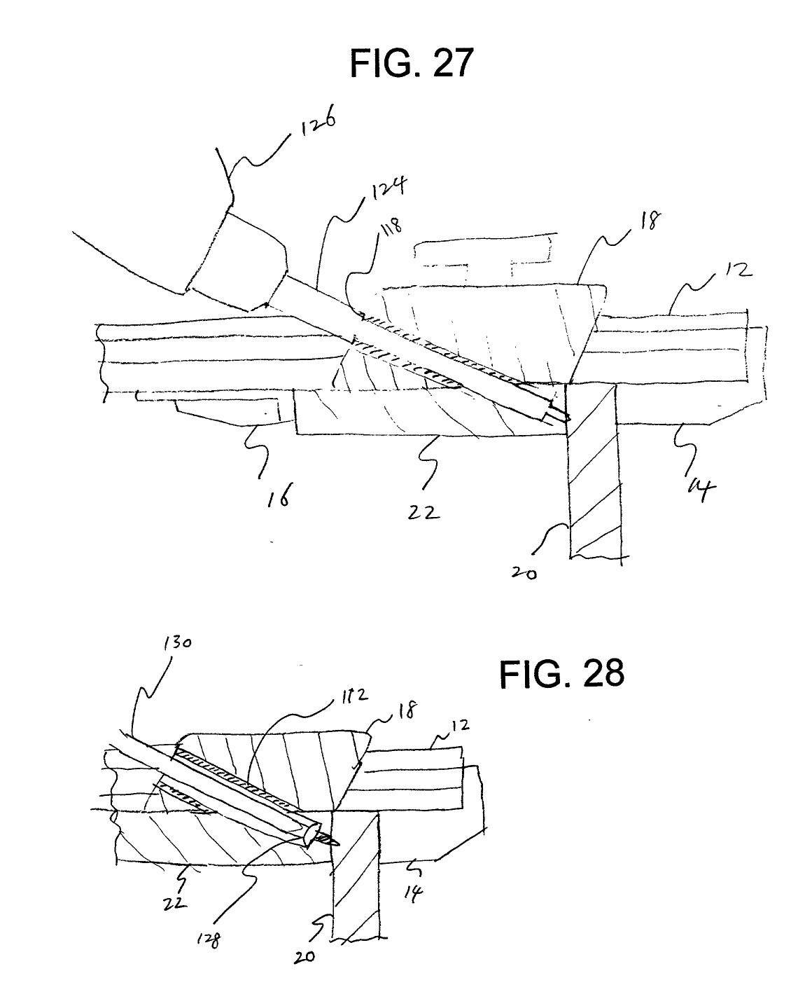

FIG. 27 shows that a pocket hole is formed in the workpiece 20. The stop flange 118 prevents the drill bit 113 from drilling more than the required depth of the pocket hole.

FIG. 28 shows that a screw 128 is deposited into the pocket hole thus assembling the workpieces 20, 22. A screw driver 130 is guided through the drill guide portion 112 to deposit the screw 128.

After depositing the screw 128, the cam lever 122 is pivoted to the release position. Then the spring 94 pulls in the rod 48. By moving the handle 56 of the second stop 16 away from the workpiece 22, the second stop 16 becomes its released state, as explained above, and further moving of the handle 56 moves the second stop 16 away form the work piece 22. Then the assembled workpieces 20, 22 are removed from the jig 10.

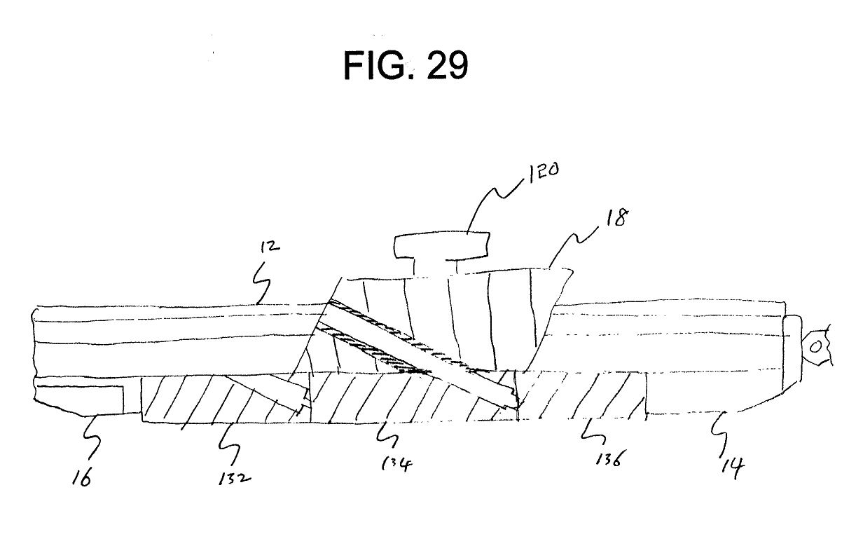

FIG. 29 shows three workpieces 132, 134, 136 clamped by the jig 10. The workpieces are positioned horizontally. The drill guide 18 moves along the base 12 from workpiece to workpiece to form pocket joints.

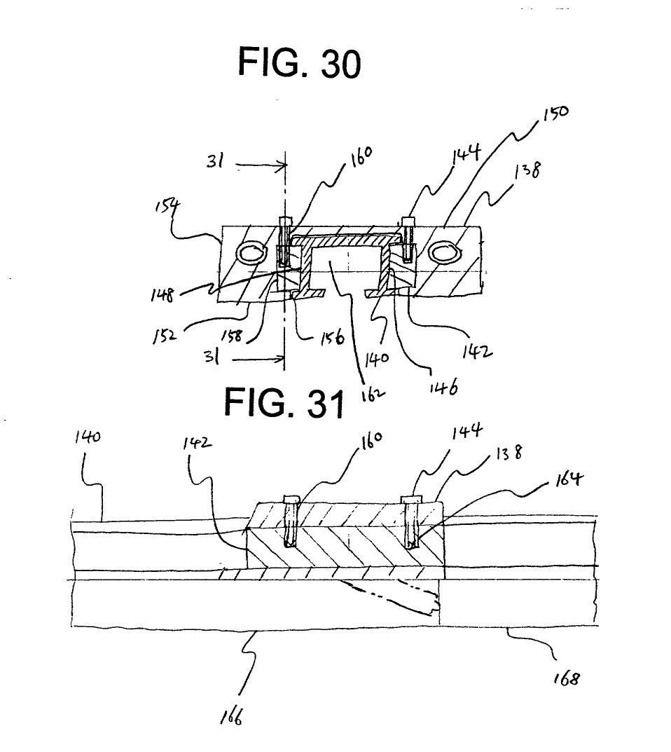

FIGS. 30, 31 show an alternative clamping mechanism for a drill guide. FIG. 30 shows a drill guide 138, a base 140, two keys 142, and two bolts 144. The base 140 has two sidewalls 146. Each of the sidewalls has a keyway or groove 148. The drill guide 138 has an upper surface 150, a lower surface 152, and two sidewalls 154 connecting the upper surface 150 and the lower surface 152. The lower surface 152 has an opening 156. Each of the sidewalls 154 has a keyway or groove 158, and two bores 160. The opening 156, the sidewalls 154, and the upper surface 150 form a channel 162 receiving the base 140. Each of the keys 142 has two threaded holes 164. The keys 142 are inserted between the keyway 148 of the base and the keyway 158 of the drill guide. The bolts 144 pass through the bores 160 of the drill guide and engage with the threaded holes 164 of the keys.

FIG. 31 shows the drill guide 138 is secured in a position to drill pocket holes shown by imaginary lines in a workpiece 166 to assemble the workpiece 166 to an adjacent workpiece 168. As the bolts 144 are tightened the lower surface 152 is pressed against the workpiece 166 thereby providing additional clamping effects.

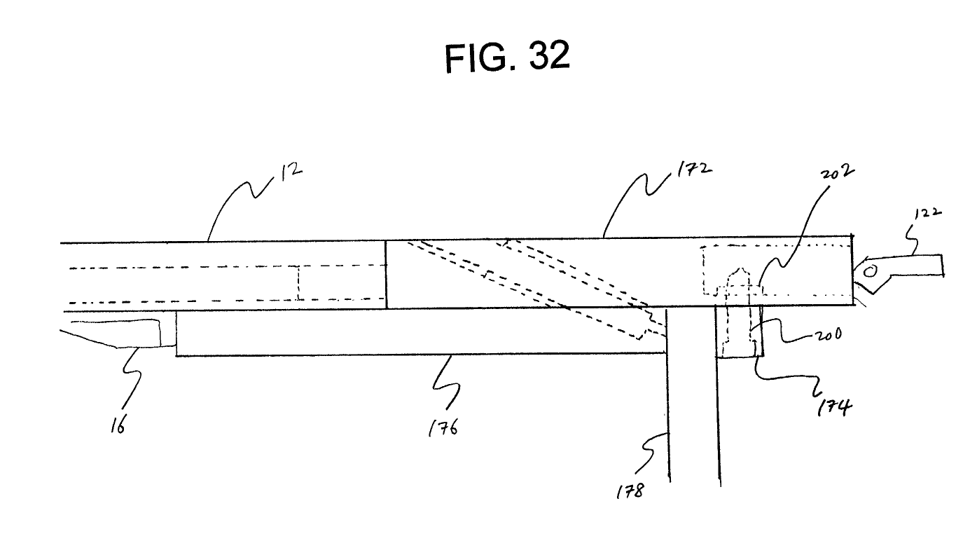

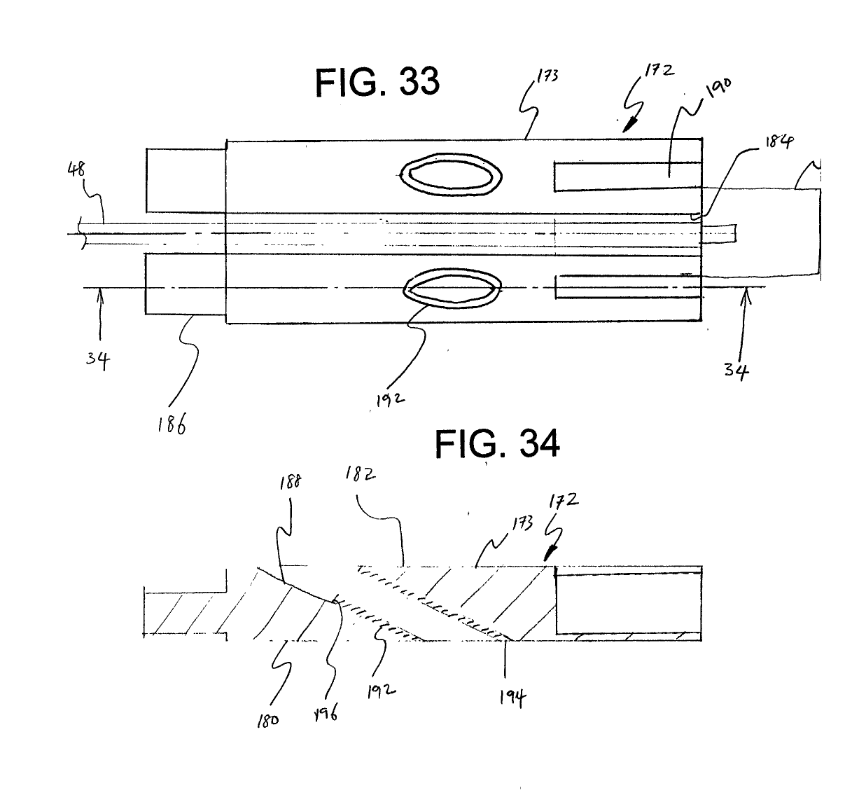

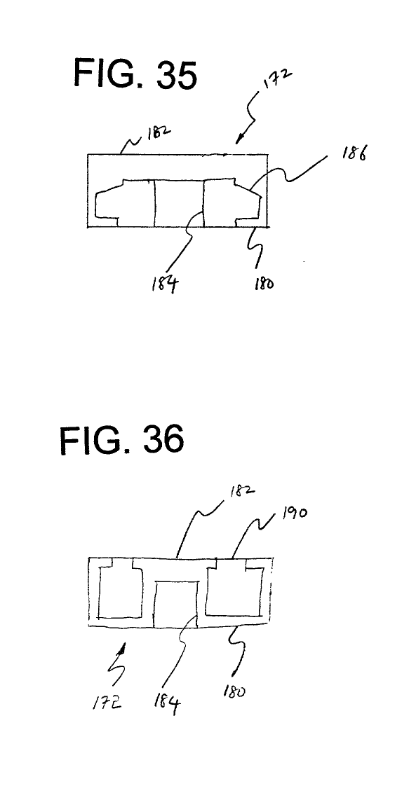

FIGS. 32-39 show a pocket hole drilling and screw installation jig 170 according to the second embodiment of the present invention. The jig 170 may also be used as a straight edge clamping device for woodworking. The second embodiment is different from the first embodiment in that a drill guide 172 is fixed to the end 36 of the base 12, and a first stop 174 is movably secured to the drill guide 172.

FIG. 32 shows two workpieces 176, 178 secured between the first stop 174 and the second stop 16. The movable first stop 174 accommodates varying thickness of the workpiece 178 to properly position the workpieces 176, 178 relative to the drill guide 172.

As shown in FIGS. 32-36, the drill guide 172 has a body 173 and two drill guide portions 192. The body 173 has a lower surface 180 that is flush with the lower wall 24 of the base 12, an upper surface 182 that is opposite with the lower surface 180, a channel 184 to receive the rod 48, two projections 186 inserted into the end 36 of the base 12, two through holes 188 obliquely formed in the body 173, and two channels 190 positioned opposite to the projections 186 are provided in a shape of a bushing to accommodate the first stop 174. Each of the drill guide portions 192 has an end 194 terminating flush with the lower surface 180 and a stop flange 196 at the other end. The drill guide portions 192 are inserted into the holes 188. The drill guide portions 192 may be omitted and the holes 188 may guide the drills. In this case, stop flanges are provided at the holes 188. The holes 188 and thus the drill guide portions 192 may be positioned with the width of the base because the drill 172 is fixed to the end of the base 12.

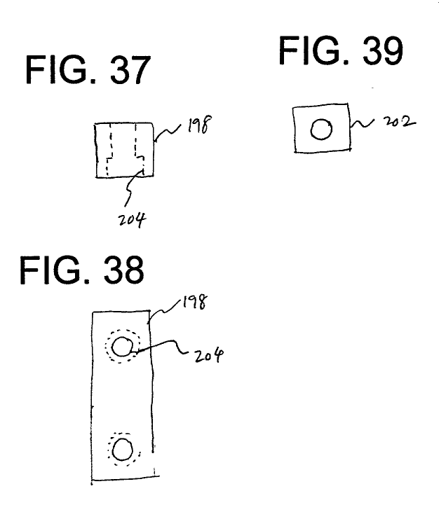

As shown in FIGS. 37-39, the first stop 174 includes a rectangular stop block 198, two bolts 200 (refer to FIG. 2), and two square nuts 202. The stop block 198 has two stepped bores 204 to receive the bolts 200. The square nuts 202 are received in the channels 190 of the drill guide 172.

The second stop 16 secures the workpiece 176 and then the cam lever 122 is pivoted to tightly clamp the workpieces 176, 178. After the workpieces 176, 178 are properly positioned relative to the drill guide 172, the stop block 198 is moved to contact the workpiece 178, and the bolts 200 are fastened to the nuts 202 thereby fixing the first stop 174 to the drill guide 172. Drilling pocket holes and depositing screws are performed similarly as explained in the first embodiment.

With the above construction, the step of forming pocket holes in workpieces and the step of assembling workpieces can be performed with single clamping step of the workpieces.

In the first embodiment, the drill guide 18 is movable along the base 12 so that the jig 10 can accommodate varying thickness, length or width of the workpieces. In the second embodiment, the first stop 174 is movable along the drill guide 172 so that the jig 170 can accommodate varying thickness, length, or width of the workpieces.

Also, in the second embodiment, since the drill guide 172 is attached the one end 36 of the base 12, the drill guide portions 192 may be spaced closer, for example within the width of the base 12.

Necessary adjustments to the workpieces' final assembled position can be readily made before drilling, ensuring the best position of the pocket holes because the workpieces are clamped in their final position before drilling and the position is kept until removing them after installing screws.

The workpieces are additionally tightened by the drill guide, providing smooth and accurate drilling.

Two or more workpieces can be secured edge to edge into their final position and assembled.

The drill guide can be repositioned to a new position along the clamping mechanism on the same edge clamped workpieces without unclamping the workpieces.

Although the invention has been described in considerable detail, other versions are possible by converting the aforementioned construction. Therefore, the scope of the invention shall not be limited by the specification specified above and the appended claims.

What is claimed is:

1. A pocket hole drilling and screw installation jig for workpieces comprising:
a) a bar-shaped base having a flat lower surface along its length, a first end, and a second end for contacting one or more workpieces with the lower surface;
b) a first stop fixed at the first end of the base for securing a first workpiece;
c) a second stop movably provided along the base for securing a second workpiece;
d) a clamp for holding the workpieces together; and
e) a drill guide movably provided along the base for guiding a drill for forming a pocket hole;
wherein the drill guide has a body, and through holes obliquely formed in the body,
wherein:
the body has a flat lower surface and an upper surface and the lower surface of the body is substantially parallel with the lower surface of the base; and
each of the through holes form a drill guide portion; the drill guide portion has a lower end and
an upper end; and the lower end terminates flush with the lower surface of the body.

2. The pocket hole drilling and screw installation jig for workpieces of claim 1 wherein each of the drill guide portions is made of a bushing and inserted into the through holes of the drill guide.

3. The pocket hole drilling and screw installation jig for workpieces of claim 1 wherein each of the drill guide portions has a stop flange at the upper end to limit drilling depth.

4. The pocket hole drilling and screw installation jig for workpieces of claim 2 wherein each of the drill guide portions has a stop flange at the upper end to limit drilling depth.

5. The pocket hole drilling and screw installation jig for workpieces of claim I wherein the body of the drill guide is made of cast aluminum, extruded aluminum, or molded plastic.

6. The pocket hole drilling and screw installation jig for workpieces of claim 2 wherein the drill guide portions are made of hardened steel.

7. The pocket hole drilling and screw installation jig for workpieces of claim 1 wherein an angle between the holes of the drill guide and the lower surface of the base is approximately 14 degrees.

8. A pocket hole drilling and screw installation jig for workpieces of claim 1 wherein the drill guide further comprises a clamp; the clamp secures the drill guide to the base and presses the lower surface of the body against a workpiece to be drilled.

9. The pocket hole drilling and screw installation jig for workpieces of claim 8 wherein the clamp of the drill guide comprises a nut and a knob; the nut has a head and a threaded portion; the knob has a threaded portion which engages with the threaded portion of the nut; the body of the drill guide further comprises a bore; the threaded portion of the nut passes through the bore; and the base further comprises a guide channel in which the head of the nut slides and is secured.

10. A pocket hole drilling and screw installation jig for workpieces of claim 8 wherein the base further comprises two sidewalls, each of the sidewalls having a groove, wherein the body of the drill guide further comprises two sidewalls connecting the upper surface and the lower surface, the lower surface having an opening, wherein each of the sidewalls has a groove and a plurality of bores, wherein the opening of the lower surface, the sidewalls, and the upper surface form a channel receiving the base, wherein the clamp of the drill guide has a plurality of bolts, and two keys having a plurality of threaded holes, wherein the keys are inserted between the groove of the base and the groove of the drill guide, and the bolts pass through the bores of the drill guide and engage with the threaded holes of the keys.

11. The pocket hole drilling and screw installation jig for workpieces of claim 1 wherein:
the base further comprises a channel formed along its length;
the first stop comprises a first wall contacting the first workpiece, and a second wall positioned opposite to the first wall;
the clamp comprises a rod housed in the channel of the base, a spring, an end cap fixed at the second end of the base and housing the spring, and a cam lever; wherein:
the rod has a first end, a second end, and a stop provided at the first end;
the end cap has a first wall covering the second end of the base and a second wall positioned opposite to the first wall;
the spring is positioned around the rod between the second wall of the end cap and the stop of the rod; and the cam lever is pivotally attached to the second end of the rod and abuts the second wall of the first stop; and the second stop comprises a lock engaging the rod of the clamp for allowing movement of the second stop only in the direction toward the first stop when the lock is engaged and for allowing movement of the second stop in both direction along the base when the lock is released.

12. A pocket hole drilling and screw installation jig for workpieces comprising:
a) a bar-shaped base having a flat lower surface along its length, a first end, and a second end for contacting one or more workpieces with the lower surface;
b) a drill guide attached at the first end of the base for guiding a drill for forming a pocket hole;
c) a first stop movably provided along the drill guide for securing a first workpiece;
d) a second stop movably provided along the base for securing a second workpiece; and
e) a clamp for holding the workpieces together;
wherein the drill guide has a body, and drill guide portions, and wherein:
the body has a flat lower surface and a upper surface; and the lower surface of the body is flush with the flat surface of the base; and
each of the drill guide portions is formed by a through hole obliquely formed in the body; the hole has a lower end and an upper end; and the lower end terminates flush with the lower surface of the body.

13. The pocket hole drilling and screw installation jig for workpieces of claim 12 wherein each of the drill guide portions is made of a bushing and inserted into the through holes of the drill guide.

14. The pocket hole drilling and screw installation jig for workpieces of claim 12 wherein each of the drill guide portions has a stop flange at the upper end to limit drilling depth.

15. The pocket hole drilling and screw installation jig for workpieces of claim 13 wherein each of the drill guide portions has a stop flange at the upper end to limit drilling depth.

16. The pocket hole drilling and screw installation jig for workpieces of claim 12 wherein the body of the drill guide is made of cast aluminum, extruded aluminum, or molded plastic.

17. The pocket hole drilling and screw installation jig for workpieces of claim 13 wherein the drill guide portions are made of hardened steel.

18. The pocket hole drilling and screw installation jig for workpieces of claim 12 wherein an angle between the holes of the drill guide and the lower surface of the base is approximately 14 degrees.

19. The pocket hole drilling and screw installation jig for workpieces of claim 12 wherein:
the base further comprises a channel formed along its length;
the drill guide further comprises a first end inserted into the channel of the base for attaching the drill guide to the base, and a second end positioned opposite to the first end and having one or more channels to receive the first stop;
the first stop has a stop contacting the first workpiece, and a fastener fixing the stop on the drill guide;
the clamp comprises a rod housed in the channel of the base, a spring, an end cap fixed at the second end of the base and housing the spring, and a cam lever; wherein:
the rod has a first end, a second end, and a stop provided at the first end;
the end cap has a first wall covering the second end of the base and a second wall positioned opposite to the first wall;
the spring is positioned around the rod between the second wall of the end cap and the stop of the rod; and the cam lever is pivotally attached to the second end of the rod and abuts the second end of the drill guide; and the second stop comprises a lock engaging the rod of the clamp for allowing movement of the second stop only in the direction toward the first stop when the lock is engaged and for allowing movement of the second stop in both direction along the base when the lock is released.
